(19) United States
(12) Patent Application Publication
(10) Pub. No.: US 2024/0403594 A1
(43) Pub. Date: Dec. 5, 2024

(54) ANTENNAS IN RADIO FREQUENCY IDENTIFICATION (RFID) TAGS

(71) Applicant: CCL Label, Inc., Framingham, MA (US)

(72) Inventors: Henry Nguyen, Holland, MI (US); Michael Isabell, East Grand Rapids, MI (US); Zach Wagner, Grand Rapids, MI (US)

(21) Appl. No.: 18/679,543

(22) Filed: May 31, 2024

Related U.S. Application Data
(60) Provisional application No. 63/470,191, filed on Jun. 1, 2023.

(51) Int. Cl. G06K 19/077; B32B 27/28

(52) U.S. Cl. CPC G06K 19/07777; B32B 27/285; G06K 19/07758

(57) ABSTRACT

Provided is a radio frequency identification (RFID) inlay comprising an antenna with a loop on a substrate; an integrated circuit (IC) connected to the loop, wherein the loop provides inductance for the IC, and wherein the antenna has an asymmetric design. The antenna comprises a cross hatch pattern comprising of connection lines to form rectangles, meander lines on one or more sides of the loop, or a solid bar on one or more sides of the loop.

### CROSS-REFERENCE TO RELATED APPLICATIONS

The present application claims priority to and the benefit of U.S. Provisional Patent Application No. 63/470,191 entitled “ANTENNAS IN RADIO FREQUENCY IDENTIFICATION (RFID) TAGS” filed on Jun. 1, 2023, the disclosure of which is incorporated herein by reference in its entirety.

### TECHNICAL FIELD

The present application relates to antennas for use in RFID tags, RFID tags comprising such antennas, and methods of making and using the same. In particular, the present application relates to antenna configurations and arrangements suitable for constructing and providing RFID inlays and labels.

### BACKGROUND

Depending on the type of RFID tags (e.g., RFID labels and inlays) which is based on the range of frequencies, the antennas in RFID tags can have a typical design with a loop in the middle and meander lines or solid blocks of material symmetrically arranged on opposite sides of the loop that is connected to the integrated circuit (IC) or microchip. The antennas in RFID tags are almost always symmetrically designed. As such, there can be disadvantages to having symmetrically designed antennas in RFID tags as there is still a need to optimize the read range of RFID tags on high dielectric objects, overcome parasitic capacitance, ease read range tuning capabilities, and safeguard the IC (e.g., microchip) from damage.

### SUMMARY

The following presents a summary of this disclosure to provide a basic understanding of some aspects. This summary is intended to neither identify key or critical elements nor define any limitations of embodiments or claims. This summary may provide a simplified overview of some aspects that may be described in greater detail in other portions of this disclosure. Furthermore, any of the described aspects may be isolated or combined with other described aspects without limitation to the same effect as if they had been described separately and in every possible combination explicitly.

In one aspect, provided is an RFID inlay that comprises an antenna with a loop on a substrate; and an integrated circuit (IC) connected to the loop, wherein the loop provides inductance for the IC, and wherein the antenna has an asymmetric design.

In one embodiment, the antenna comprises a cross hatch pattern comprising connection lines to form rectangles on one or more sides of the loop.

In one embodiment, the antenna comprises meander lines on one or more sides of the loop.

In one embodiment, the antenna comprises a solid bar on one or more sides of the loop.

In another aspect, provided is an RFID label assembly comprising a liner; an inlay comprising: an antenna with a loop disposed on a substrate; and an integrated circuit (IC) connected to the loop, wherein the loop provides inductance for the IC, and wherein the antenna has an asymmetric design; a first adhesive layer underlying the substrate; a facestock with printed artwork or information, wherein the facestock is attached to the inlay by a second adhesive layer; and optionally, a polyethylene terephthalate (PET) film over the facestock, wherein the PET film is clear and provides protection for the RFID label assembly.

In one embodiment, the antenna comprises a cross hatch pattern comprising connection lines to form rectangles on one or more sides of the loop.

In one embodiment, the antenna comprises meander lines on one or more sides of the loop.

In one embodiment, the antenna comprises a solid bar on one or more sides of the loop.

In still another aspect, provided is a method of creating an overlapped RFID label comprising measuring a circumference of an item; determining a dimension of the RFID label such as a length of the RFID label; determining one or more pinch points on the RFID label from a label applicator; designing the RFID label so that an IC is in an area with little or no pressure; and designing a facestock for the RFID label to fit in an area not being overlapped by the RFID when the RFID label is applied on the item.

In yet another aspect, provided is a method of tuning an RFID tag comprising determining a read range of the RFID tag on an item; determining whether the read range is within a desired read range; and if the read range is not within the desired read range, removing one or more connection lines on the RFID tag with a cross hatch pattern, so that remaining connection lines maintain an enclosed rectangle shape, until the desired read range is reached.

The following description and the drawings disclose various illustrative aspects. Some improvements and novel aspects may be expressly identified, while others may be apparent from the description and drawings.

### DESCRIPTION OF THE DRAWINGS

The accompanying drawings illustrate various systems, apparatuses, devices and methods in which like reference characters refer to like parts throughout, and in which:

FIG. 1 illustrates an explosive view of an RFID label assembly in accordance with various disclosed aspects herein;

FIG. 2 illustrates a cross-section of the RFID label assembly from FIG. 1 in accordance with various disclosed aspects herein;

FIG. 3A illustrates a top view of an RFID label in accordance with various disclosed aspects herein;

FIG. 3B illustrates a front view of a vial with an attached RFID label from FIG. 3A in accordance with various disclosed aspects herein;

FIG. 3C illustrates a back view of a vial with an attached RFID label from FIG. 3A in accordance with various disclosed aspects herein;

FIGS. 4A-13B illustrate embodiments of RFID antenna configurations in accordance with various disclosed aspects herein;

FIGS. 14-15 illustrate flow diagrams in accordance with various disclosed aspects herein.

The disclosed embodiments may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” mean an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

RFID tags can be designed as RFID inlays or as RFID labels for end-user items. RFID inlays can be produced for label convertors to turn the RFID inlays into RFID labels. RFID inlays can also be embedded directly into objects. The read range of an RFID tag (e.g., RFID inlay or RFID label) can dramatically change depending on what object the RFID tag is applied on due to the dielectric properties of that object. As used herein, the term “RFID tags” or “RFID tag” can be used interchangeably to mean RFID inlay(s) or RFID label(s). Also, as used herein, the terms “grid pattern,” “cross hatch pattern,” and “waffle pattern” can be used interchangeably to describe an antenna pattern.

Different objects such as, but not limited to, cardboard, plastic, metal, or glass can result in different read ranges for the same RFID tag. For example, an RFID tag designed for a cardboard box with the best possible read range can have a lower read range if it is placed on a glass vial containing liquid due to that vial's dielectric properties which can change the capacitance of what the integrated circuit (IC) (e.g., microchip) is able to receive from the radio-wave reader or RFID reader. The dielectric properties of a glass vial containing liquid can severely detune (e.g., shift frequency or shift capacitance) so that the read range of the RFID tag may be significantly decreased. As another example, an RFID tag that is used on a cardboard box may have a 30 feet read range, however, if this same RFID tag is placed on a glass vial containing liquid it may have a read range of 2 feet. By changing the object on which the RFID tag is placed, the sensitivity or read range of that RFID tag can be dramatically shifted and in some cases significantly decreased.

Two common sources of interference for RFID tags include metal and liquid. With liquid, the RFID tag, or more specifically, the antenna, can be modified or tuned to work well with that liquid. Metals can be more challenging to work with as metals can detune a conventional RFID tag. For example, dense aluminum can disrupt readability and detune an RFID tag so that read performance may be poor. In addition, the parasitic capacitance between two or more RFID tags placed in proximity to one another can also interfere with each other's read range. For example, an existing inventory system trying to read individual RFID tags on vials in a densely packed medical tray containing other vials with RFID tags can exhibit poor read performance.

The RFID tag, or more specifically, the antenna can be designed to improve read performance on high dielectric objects or improve parasitic capacitance rejection. However, the typical method of producing an RFID tag uses a simulation process that may take hours, days, or even weeks depending on the complexity of the design. The typical method uses an electromagnetic simulation software to draw an antenna pattern and import the material used in making the RFID tag and the object the RFID is used on. This can include the type of substrate that holds the antenna, the type of object upon which the RFID tag will be placed on, and the dielectric properties of that object. The electromagnetic simulation software then analyzes how well the IC is read and how well the RFID tag matches the intended use. This process involves a lot of theoretical calculations to figure out what RFID tag designs work best to provide the appropriate on-product performance.

There is also the risk that the IC will be damaged during the label application process. The ICs in RFID labels can be prone to damage due to pressure exerted on the ICs by label applicators. Label applicators may use an incredible amount of force to adhere the RFID labels onto objects which can cause the ICs to be damaged under pressure at certain pinch points. The embodiments disclosed herein can overcome these problems in the RFID labeling process. The embodiments disclosed herein also pass Auburn University's ARC Spec certification which involves on-item testing and testing in free air without an article or item behind the RFID tag.

RFID labels can have a facestock with printed artwork or information such as, but not limited to, an electronic product code (EPC), an intermediary layer called an inlay, and an adhesive backing. The inlay can comprise an antenna with a loop on a substrate and an IC connected to the loop. The loop can provide inductance for the IC. The antenna can be formed from any suitable material, as is now known or later discovered in the art. Examples of suitable materials include, but are not limited to, aluminum, copper, silver, gold, other metals, carbon, and the like. The antennas may also be printed in conductive inks comprising dispersions of silver, gold, or other metals, or particles coated with silver, gold or other metallic conductors, or nonmetallic conductors such as carbon or polyaniline.

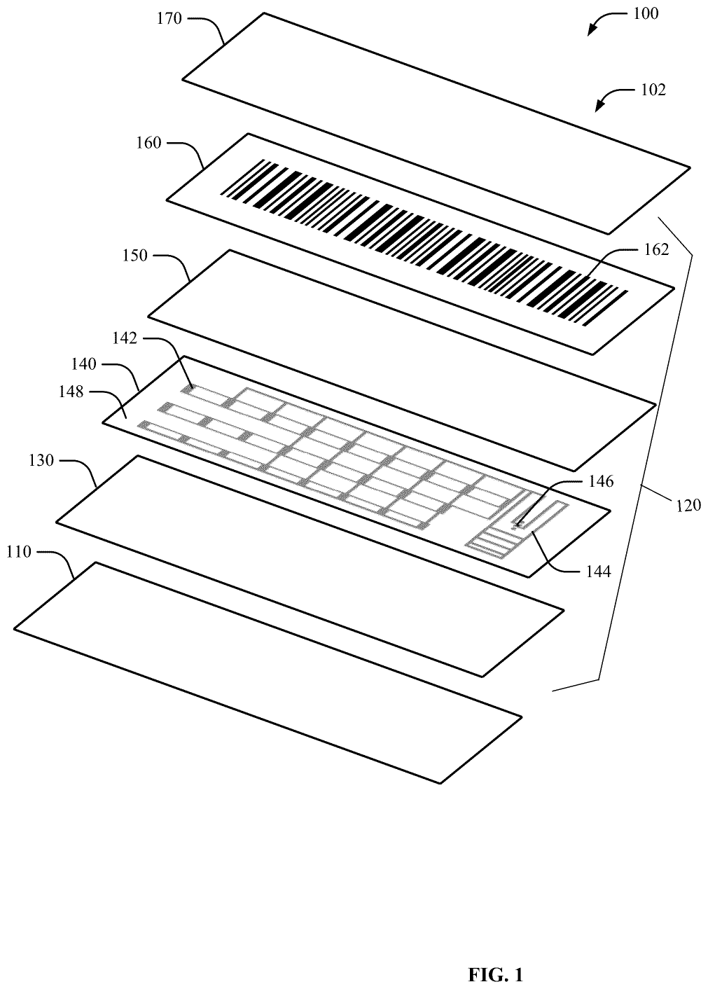

The antennas may be formed in any suitable manner as is now known or later discovered. Examples of methods of forming the antenna include, but are not limited to, etching, die cutting, printing, laser ablation, and the like. In one embodiment, the antennas may be formed by die cutting and adhering the antennas to the substrates. In one embodiment, the antenna may be formed by grinding away conductive material that has been laminated to the substrates. In one embodiment, the antenna may be formed by printing or particle deposition, or by laser ablation. The antenna may be placed on top of the substrate, or the antenna may be embedded within the substrate. The substrate may also serve an additional purpose as one of the other layers shown in the inlay construction of FIG. 1. The thickness of the antenna can be selected as desired for a particular application or intended use. In embodiments, the antenna can have a thickness of about 10 microns.

Unlike conventional RFID tags, the disclosed RFID tags can have asymmetrical antennas. The asymmetric antenna comprises a loop (e.g., loop portion) with an antenna part radiating from at least one side of the loop portion. The antenna is asymmetrical in that the antenna has (i) one member radiating from a side of the loop portion, or (ii) a member radiating from each side of the loop portion, wherein the members are not identical to one another in terms of length, pattern, or shape of the radiating member. In one embodiment, the asymmetrical antenna comprises one or more members radiating from one or more sides of the loop, wherein the one or more members comprise a grid pattern, cross hatch pattern, or waffle pattern. In another embodiment, the asymmetrical antenna comprises one or more members radiating from one or more sides of the loop, wherein the one or more members comprise one or more meander lines. In yet another embodiment, the asymmetrical antenna is an asymmetric dipole that comprises a solid bar radiating from one or more sides of the loop. An asymmetric dipole with a solid bar can have the same performance, sensitivity, and read range as the cross hatch or waffle pattern. However, an asymmetric dipole can have a very high performance on high dielectric or difficult to tag objects or products such as, for example, glass vials containing liquid. In addition to liquids, other examples of objects whose dielectric properties change the performance of RFID tags include, but are not limited to, rubbers such as neoprene, glasses such as borosilicate glass, and plastics or composites such as polyvinyl chloride (PVC), polytetrafluoroethylene (PTFE), and flame retardant 4 (FR4).

It has been found that antennas that have a cross hatch or waffle pattern can have good parasitic capacitance rejection that allows the RFID tags to respond back to an RFID reader with less of an interference from other densely packed RFID tags. In some embodiments, an asymmetric dipole with one or more solid bars can incorporate a waffle pattern. With an asymmetric dipole that incorporates a waffle pattern, it has been observed to have improved performance on high dielectric objects and improved parasitic capacitance rejection.

The present antenna configurations may also allow for modification of the antenna design such that the frequency of the antenna can be tuned. As used herein, the term “tuning” can mean adjusting a read range of an RFID tag and can mean increasing or decreasing that read range. While the ultimate goal of tuning the antenna is to achieve a desired read range, tuning also involves altering the frequency response and resonant frequency of the antenna to accommodate the influence of different objects which the antenna is on or nearby. In attempting to read multiple tags in a dense population environment, other RFID tags may potentially influence or interfere with the read range of a tag. In modifying or tuning the antenna, the modification may be carried out through a manual process, or by a mechanized or automated process. The modification may be done on a small scale for the purpose of research and design testing, or it may be performed on a large scale for the purpose of mass production. For example a large number of identical antennas could be produced, with a modification (e.g., such as a specific die cut to remove the traces) being carried out on each antenna during a conversion process so that a variety of resulting antennas which are tuned for their specific application are created.

More specifically, an antenna can be modified or tuned by a simple mechanical removal of one or more elements or connection lines in the antenna to get a different read range for different objects. As an example, an antenna with a cross hatch pattern can be tuned by removing one or more elements or connection lines in the antenna for fine-tuning of the frequency response, an antenna with meander lines can be tuned by removing part of the meander lines, and an symmetric dipole can be tuned by removing part of the solid bar. Selectively adding antenna elements to the configuration is possible, but it is generally not as practical as removing antenna elements. The ability to tune an RFID tag by modifying the antenna to adjust the read range can provide additional combinations of radio frequency responses without needing to go through the full process of designing an RFID tag for every new product. Existing RFID tags can be modified to meet the specifications of new products without needing to go through the simulation process. By removing antenna elements in the RFID tag and detecting the read range of the modified RFID tag, the tuning can be done within minutes or hours.

As an example, if a customer want to use an existing RFID tag for a product on a different product or container, the existing RFID tag can be modified to fit the specifications of the other product or container without having to create an entirely new RFID tag. The ability to modify or tune an existing RFID can be advantageous as slight differences in products can require a different RFID tag. For example, different size vials can require different RFID tags so there would not be one design that works on all sizes of vials.

The embodiments herein also disclose designing RFID tags with the ICs strategically positioned to avoid potential pinch points. If a customer is using a label applicator, based on the area with little or no pressure applied by the label applicator, an RFID tag can be designed so that the IC is placed within an area of the RFID label with little or no pressure to avoid potential pinch points. Avoiding potential pinch points on the IC is especially possible because the IC does not have to be symmetrically located on the RFID tag.

The avoidance of pinch points may be achieved by positioning the IC either in a position around an object's circumference which does not come into contact with a pinch point, or positioning the IC at a point along the object's vertical surface (e.g., moving the IC higher or lower) which does not come into contact with a pinch point. In either case, a method of locating pinch points can include visually examining the environment (e.g., such as a machine) where the RFID labeled object will be handled, identifying any surfaces which may come into contact with the RFID labeled object, and, using a ruler, caliper, or other tool, measure to a common reference both the potential pinch point and the object to determine where on the object a pinch pint is likely to occur. Another method involves passing objects with applied RFID labels through the handling environment (e.g., such as a machine) and then testing the RFID labels after handling to determine if they have suffered damage. If necessary, the RFID labels can be tested after passing through successively smaller sections of the handling environment until the pinch point becomes apparent.

An RFID label can also be designed so that the RFID label overlap onto itself to provide additional protection for the IC. Traditionally, RFID labels on containers do not cover the full circumference of the containers, so the labels do not overlap onto itself. An RFID label with a symmetric antenna having a centrally located IC, if overlapped onto itself may overlap on the IC and cover the facestock. However, an asymmetric RFID antenna that places the IC at an edge of an RFID label can overlap the IC without covering the facestock. For example, an RFID label that is long enough to wrap around the circumference of a container, such as, but not limited to, a vial, the rear edge of the RFID label overlaps the leading edge, and an IC positioned at the leading edge can receive protection from the overlapped material. The IC can also be positioned at the rear edge of the RFID label and the leading edge can overlap the rear edge to provide protection for the IC. As long as the IC is placed at one of the edges rather than in the middle of the RFID label, one of the edges of the RFID label can overlap the other edge over the IC to provide it protection. An RFID label may have printed artwork or information that would be covered if the RFID label overlap onto itself entirely. However, it is contemplated that the RFID label can be designed so that the overlapping portion is clear so that the RFID label can overlap itself entirely without obscuring any printed artwork or information. Similarly, clear material can be adhered over the RFID label or the RFID label can be designed with an extra layer of clear film to provide the IC more protection.

FIG. 1 is an exploded view 100 of an embodiment of an RFID label assembly 102 comprising a liner 110 and an RFID label 120 comprising of an adhesive layer 130, inlay 140, adhesive layer 150, facestock 160, and polyethylene terephthalate (PET) film 170. The liner 110 can be the backing that carries and protects the adhesive layer 130 until the RFID label 120 is ready to be used and applied. The liner 110 can be configured to be easily peeled away as to not tear or damage the RFID label 120. The adhesive layer 130 can be configured to be easily peeled from the liner 110 and strong enough to adhere to an object or product with consideration to possibly needing long term durability to withstand harsh environmental conditions.

The inlay 140 comprises an antenna 142 with a loop 144 on a substrate 148, and an IC 146 is connected to the loop 144. The IC 146 can be attached to the antenna 142 and connected to the loop 144. The substrate 148 can be made of any suitable material as selected or desired for a particular application. Suitable materials include, but are not limited to, paper, or a polymeric material such as, but not limited to, polypropylene (PP), polyethylene, polycarbonate (PC), or polyethylene terephthalate (PET), and the like.

The label 120 can include adhesive layer 150 to attach the facestock 160 onto the label 120. The facestock 160 can be printed with electronic product code (EPC) 162 to identify the item that the label 120 is to be applied to. The facestock 160 can also be printed with artwork, logo, information, etc. The label 120 can also include the PET film 170 which can be a clear film to provide the label 120 with extra protection, therefore also providing extra protection for the IC 146. The RFID label assembly 102 is an example of how a label could be assembled. It is appreciated that an RFID label can be assembled with additional layers, with fewer layers, or with different layer combinations. For example, the PET film 170 can be optional. The inlay 140 can also be incorporated in other types of labels or tags such as paper tags to be hanged or fabric tags to be sewn onto a product rather than adhered to a product. It is also appreciated that the inlay 140 can also be embedded directly into an object or product.

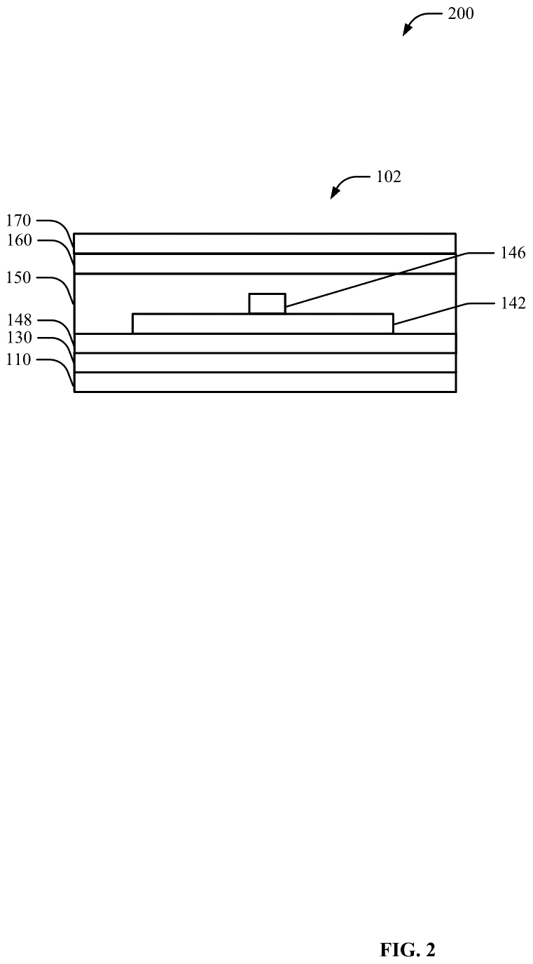

FIG. 2 illustrates a cross-section 200 of an example RFID label assembly 102 from FIG. 1 in accordance with various disclosed aspects herein. The cross-section 200 illustrates how the RFID label assembly 102 can be assembled in layers. Consecutively from one side to the other, the RFID label assembly 102 can comprise the liner 110, adhesive layer 130, substrate 148, antenna 142, IC 146, adhesive layer 150, facestock 160, and PET film 170.

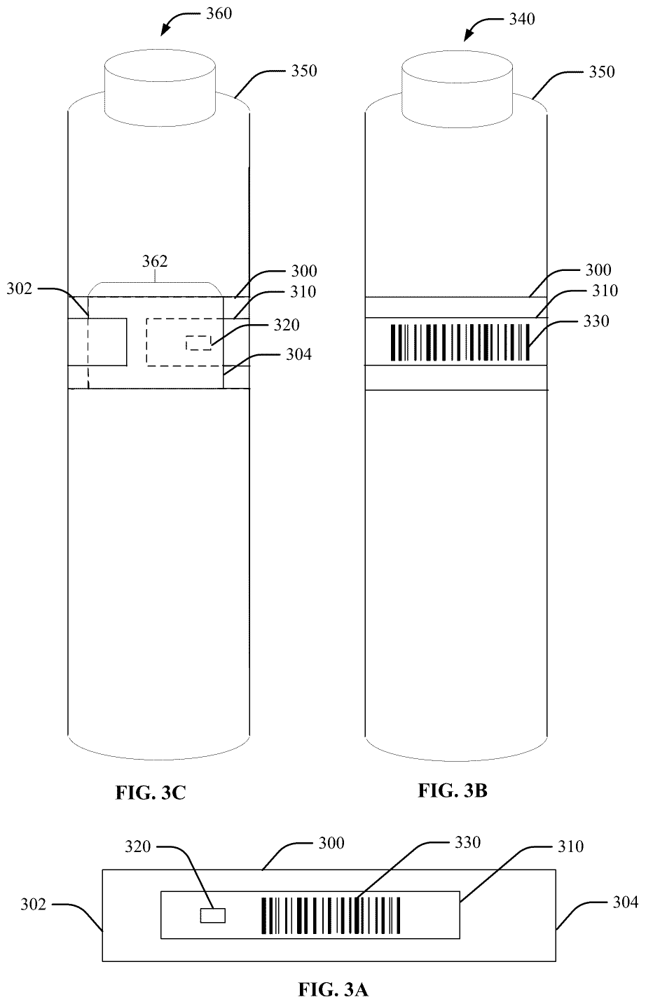

FIG. 3A illustrates a top view of an example RFID label 300 in accordance with various disclosed aspects herein. The RFID label 300 can comprise a leading edge 302, rear edge 304, antenna 310, IC 320, and EPC 330. For illustration purposes, the antenna 310 and the IC 320 are shown through the RFID label 300 so that the location of the antenna 310 and the IC 320 relative to the RFID label 300 can be seen.

FIG. 3B illustrates a front view 340 of an example vial 350 with an attached RFID label 300 from FIG. 3A in accordance with various disclosed aspects herein. The RFID label 300 can be applied on the vial 350 by hand or by a label applicator. The RFID label 300 can have pressure points or pinch points from a label applicator. Based on the location of the pinch points, the antenna 310 can be designed so that the IC 320 can be relocated to a location on the RFID label 300 with less pressure.

FIG. 3C illustrates a back view 360 of the vial 350 with the attached RFID label 300 from FIG. 3A in accordance with various disclosed aspects herein. The RFID label 300 can be designed to overlap onto itself around the vial 350. The rear edge 304 can overlap the leading edge 302 so that the overlapped portion 362 can be provided with extra protection. As illustrated, the antenna 310 can be designed so that the IC 320 can be located at the leading edge 302 and be overlapped by the overlapped portion 362 to receive additional protection.

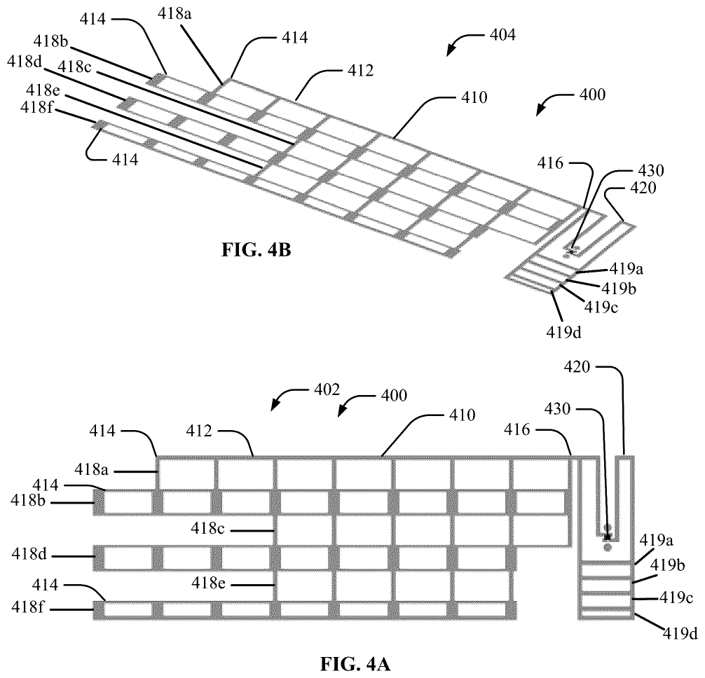

FIGS. 4A-13B illustrate embodiments of antenna configurations in accordance with various disclosed aspects herein. FIG. 4A and FIG. 4B illustrate a top view 402 and a perspective view 404, respectively, of the RFID antenna 400. The RFID antenna 400 comprises an antenna pattern 410 with a loop 420. The loop 420 can be connected to the IC 430 and provide inductance for the IC 430. The antenna pattern 410 is an asymmetric design with a cross hatch or waffle pattern comprising of connection lines 412 to form rectangles 414. The antenna pattern 410 is asymmetric with respect to the cross hatch pattern being on one side of the U-shaped rectangular loop 420. The cross hatch pattern is connected to a side of the loop 420 by connection line 416. On an adjacent side of the loop 420, with respect to the cross hatch pattern, are stacks of rectangles 419a, 419b, 419c, and 419d.

In the embodiment of FIGS. 4A and 4B, the waffle pattern comprises rows 418a, 418b, 418c, 418d, 418e, and 418f of rectangles 414. The rows 418a-f of rectangles 414 are defined by the thickness of the vertical and horizontal traces (e.g., connection lines 412). In addition to the thickness of the vertical and horizontal traces, the position of the path which the vertical and horizontal traces follow also contributes to the defined rows and rectangles. In the embodiment of FIGS. 4A and 4B, the rectangles 414 in rows 418a, 418c, and 418e have the same dimensions, the rectangles 414 in rows 418b and 418d have the same dimensions, and the rectangles 414 in row 418f has dimensions different than the other rows 418a-e. The rows 418a-f can also be configured to have different numbers of rectangles 414 within a given row 418a-f to provide the desired read range properties.

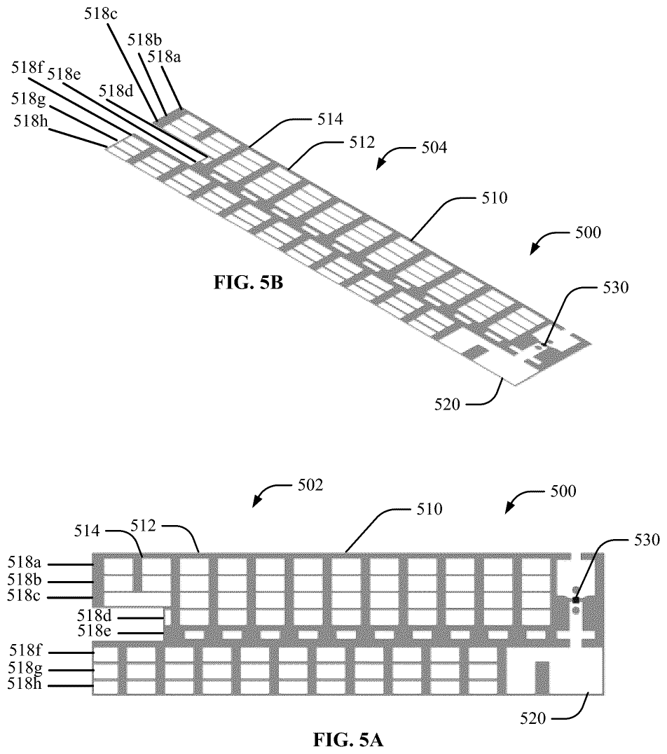

FIG. 5A and FIG. 5B illustrate a top view 502 and a perspective view 504, respectively, of the RFID antenna 500. The RFID antenna 500 comprises an antenna pattern 510 with a loop 520. The loop 520 can be connected to the IC 530 and provide inductance for the IC 530. The antenna 510 is an asymmetric design with a cross hatch or waffle pattern comprising of connection lines 512 to form rectangles 514. The antenna pattern 510 is asymmetric with respect to the cross hatch pattern being on one side of the rectangular loop 520. The cross hatch pattern is connected and adjacent to a side of the loop 520.

In the embodiments of FIGS. 5A and 5B, the waffle pattern comprises rows 518a, 518b, 518c, 518d, 518e, 518f, 518g, and 518h of rectangles 514. The rows 518a-h of rectangles 514 are defined by the thickness of the vertical and horizontal traces (e.g., connection lines 512). In addition to the thickness of the vertical and horizontal traces, the position of the path which the vertical and horizontal traces follow also contributes to the defined rows and rectangles. In the embodiment of FIGS. 5A and 5B, the rows 518a and 518b have similar dimensions, the rows 518f-h have similar dimensions and number of rectangles 514, and the rows 518c-e have one or more rectangles 514 with dimensions different from the rectangles 514 in the other rows 518a,b,f-h. The rows 518a-h can also be configured to have different numbers of rectangles 514 within a given row 518a-h to provide the desired read range properties.

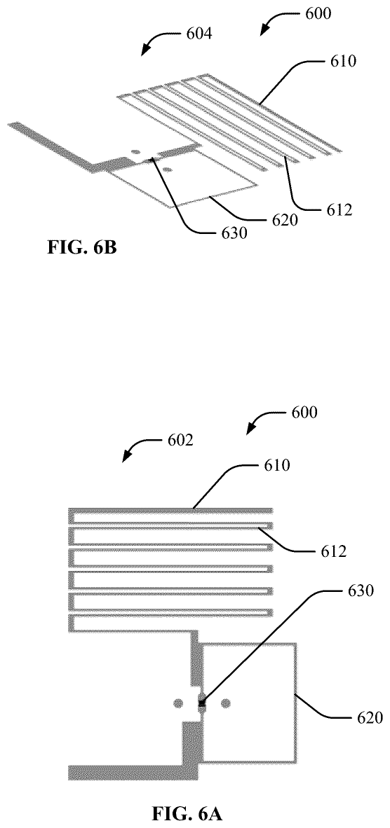

FIG. 6A and FIG. 6B illustrate a top view 602 and a perspective view 604, respectively, of the RFID antenna 600. The RFID antenna 600 comprises an antenna pattern 610 with a loop 620. The loop 620 can be connected to the IC 630 and provide inductance for the IC 630. The antenna pattern 610 can have an asymmetric design with meander line 612 on a side of the loop 620. The antenna pattern 610 is asymmetric with respect to the meander line 612 being on one side of the rectangular loop 620. The meander line 612 is in the form of a series of undulations.

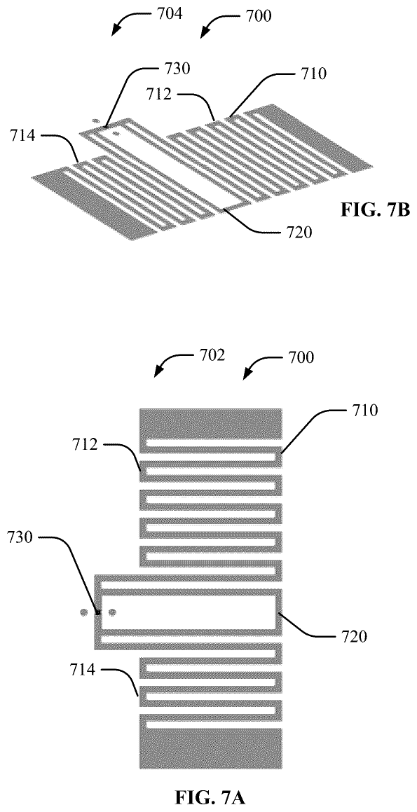

FIG. 7A and FIG. 7B illustrate a top view 702 and a perspective view 704, respectively, of the RFID antenna 700. The RFID antenna 700 comprises an antenna pattern 710 with a loop 720. The loop 720 can be connected to the IC 730 and provide inductance for the IC 730. The antenna pattern 710 can have an asymmetric design with a meander line 712 on a side of the loop 720 and a meander line 714 on a side of the loop 720 opposite of the meander line 712. The antenna pattern 710 is asymmetric as the meander lines 712 and 714 on opposite sides of the rectangular loop 720 are of unequal lengths. The meander lines 712 and 714 are in the form of a series of undulations, and the meander line 712 is longer with more undulations than the meander line 714.

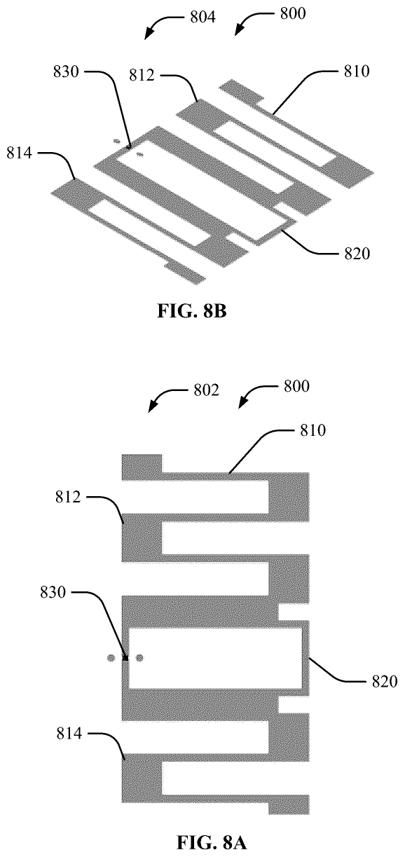

FIG. 8A and FIG. 8B illustrate a top view 802 and a perspective view 804, respectively, of the RFID antenna 800. The RFID antenna 800 comprises an antenna pattern 810 with a loop 820. The loop 820 can be connected to the IC 830 and provide inductance for the IC 830. The antenna pattern 810 can have an asymmetric design with a meander line 812 on a side of the loop 820 and a meander line 814 on a side of the loop 820 opposite of the meander line 812. The antenna pattern 810 is asymmetric as the meander lines 812 and 814 on opposite sides of the rectangular loop 820 are of unequal lengths. The meander lines 812 and 814 are in the form of a series of undulations, and the meander line 812 is longer with more undulations than the meander line 814.

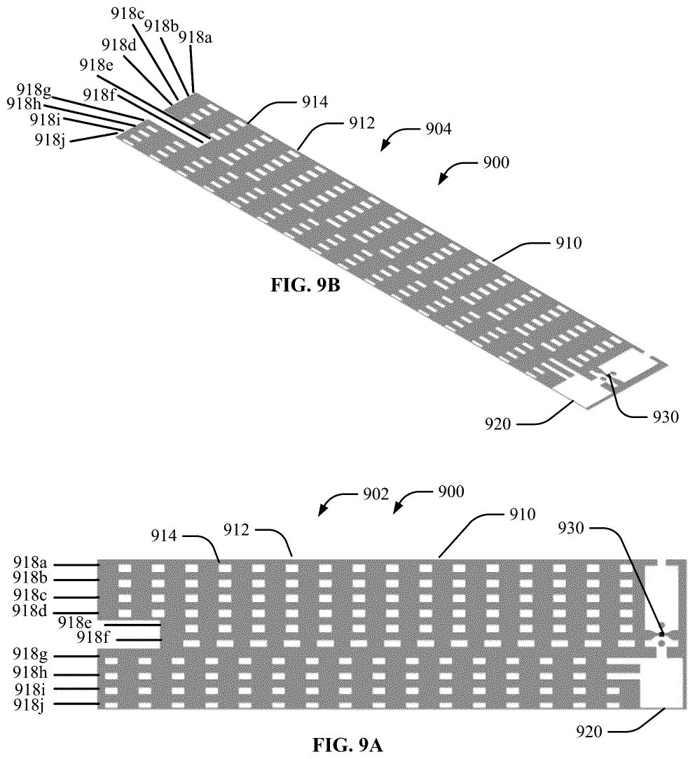

FIG. 9A and FIG. 9B illustrate a top view 902 and a perspective view 904, respectively, of the RFID antenna 900. The RFID antenna 900 comprises an antenna pattern 910 with a loop 920. The loop 920 can be connected to the IC 930 and provide inductance for the IC 930. The antenna 910 is an asymmetric design with a cross hatch or waffle pattern comprising of connection lines 912 to form rectangles 914. The antenna pattern 910 is asymmetric with respect to the cross hatch pattern being on one side of the rectangular loop 920. The cross hatch pattern is connected and adjacent to a side of the loop 920.

In the embodiment of FIGS. 9A and 9B, the waffle pattern comprises rows 918a, 918b, 918c, 918d, 918e, 918f, 918g, 918h, 918i, and 918j of rectangles 914. The rows 918a-j of rectangles 914 are defined by the thickness of the vertical and horizontal traces (e.g., connection lines 912). In addition to the thickness of the vertical and horizontal traces, the position of the path which the vertical and horizontal traces follow also contributes to the defined rows and rectangles. In the embodiment of FIGS. 9A and 9B, the rows 918a-d have the same dimensions, the rows 918g-h have the same dimensions, and the rows 918e-f and 918i-j have dimensions different than the other rows. The rows 918e-f and 918i-j have different number and/or size of rectangles 914. The rows 918a-j can also be configured to have different numbers of rectangles 914 within a given row 918a-j to provide the desired read range properties.

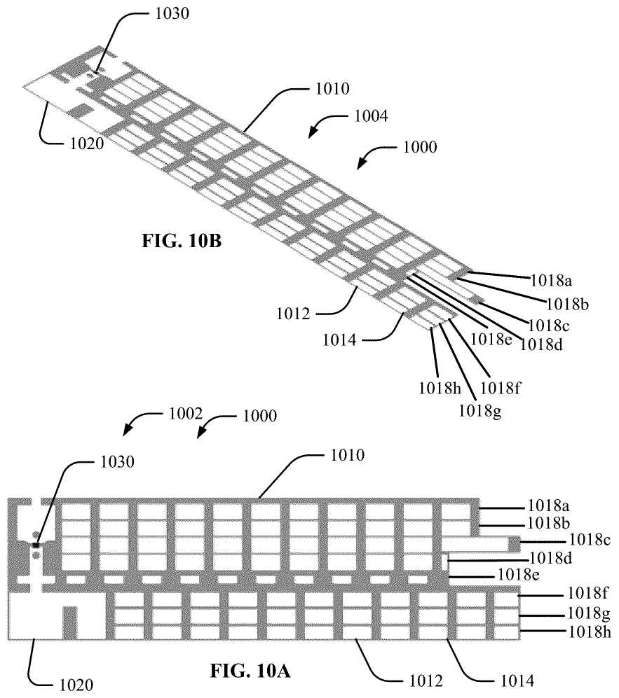

FIG. 10A and FIG. 10B illustrate a top view 1002 and a perspective view 1004, respectively, of the RFID antenna 1000. The RFID antenna 1000 comprises an antenna pattern 1010 with a loop 1020. The loop 1020 can be connected to the IC 1030 and provide inductance for the IC 1030. The antenna 1010 is an asymmetric design with a cross hatch or waffle pattern comprising of connection lines 1012 to form rectangles 1014. The antenna pattern 1010 is asymmetric with respect to the cross hatch pattern being on one side of the rectangular loop 1020. The cross hatch pattern is connected and adjacent to a side of the loop 1020.

In the embodiments of FIGS. 10A and 10B, the waffle pattern comprises rows 1018a, 1018b, 1018c, 1018d, 1018e, 1018f, 1018g, and 1018h of rectangles 1014. The rows 1018a-h of rectangles 1014 are defined by the thickness of the vertical and horizontal traces (e.g., connection lines 1012). In addition to the thickness of the vertical and horizontal traces, the position of the path which the vertical and horizontal traces follow also contributes to the defined rows and rectangles. In the embodiment of FIGS. 10A and 10B, the rows 1018a and 1018b have similar dimensions, the rows 1018f-h have similar dimensions and number of rectangles 1014, and the rows 1018c-e have one or more rectangles 1014 with dimensions different from the rectangles 1014 in the other rows 1018a,b,f-h. The rows 1018a-h can also be configured to have different numbers of rectangles 1014 within a given row 1018a-h to provide the desired read range properties.

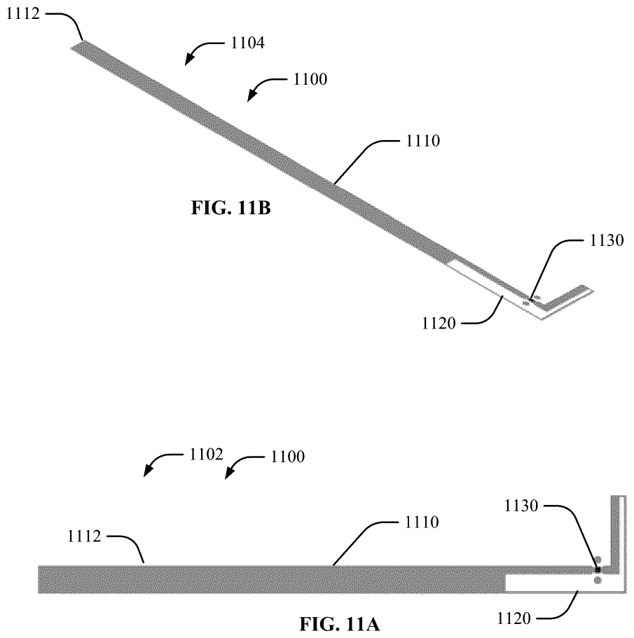

FIG. 11A and FIG. 11B illustrate a top view 1102 and a perspective view 1104, respectively, of the RFID antenna 1100. The RFID antenna 1100 comprises an antenna 1110 with a loop 1120. The loop 1120 can be connected to the IC 1130 and provide inductance for the IC 1130. The antenna pattern 1110 can have an asymmetric design with a solid bar 1112 on a side of the loop 1120. The antenna pattern 1110 is asymmetric with respect to the solid bar 1112 being on one side of the “L” shaped rectangular loop 1120.

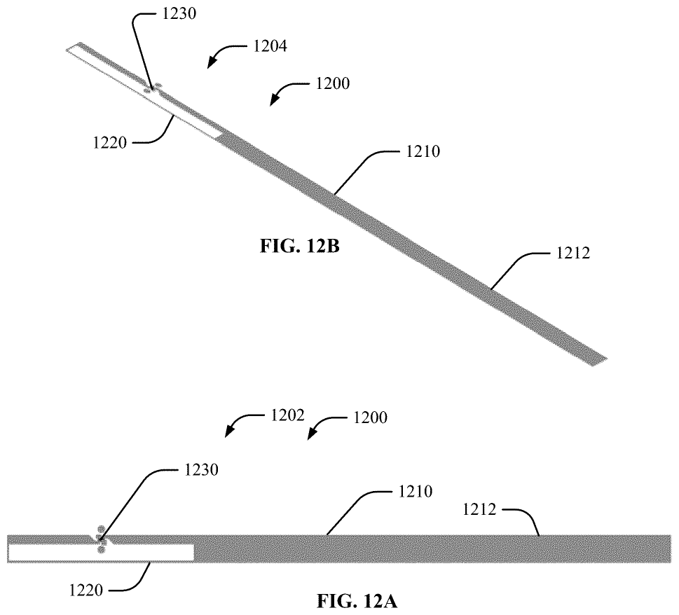

FIG. 12A and FIG. 12B illustrate a top view 1202 and a perspective view 1204, respectively, of the RFID antenna 1200. The RFID antenna 1200 comprises an antenna 1210 with a loop 1220. The loop 1220 can be connected to the IC 1230 and provide inductance for the IC 1230. The antenna pattern 1210 can have an asymmetric design with a solid bar 1212 on a side of the loop 1220. The antenna pattern 1210 is asymmetric with respect to the solid bar 1212 being on one side of the rectangular loop 1220.

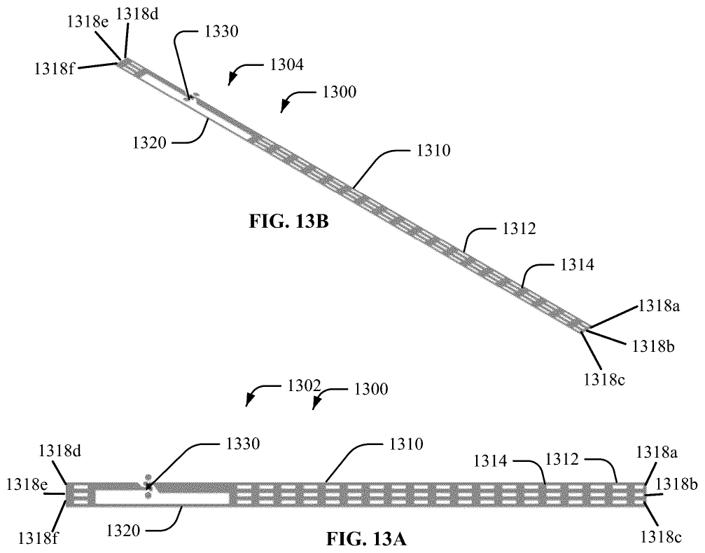

FIG. 13A and FIG. 13B illustrate a top view 1302 and a perspective view 1304, respectively, of the RFID antenna 1300. The RFID antenna 1300 comprises an antenna pattern 1310 with a loop 1320. The loop 1320 can be connected to the IC 1330 and provide inductance for the IC 1330. The antenna pattern 1310 is an asymmetric design with a cross hatch or waffle pattern comprising of connection lines 1312 to form rectangles 1314. The antenna pattern 1310 is asymmetric with respect to the cross hatch pattern being on one side of the rectangular loop 1320. The cross hatch pattern is connected and adjacent to a side of the loop 1320. On an opposing side of the loop 1320, with respect to the cross hatch pattern, are stacks of rectangles 1318d-f that are connected and adjacent to the loop 1320.

In the embodiment of FIGS. 13A and 13B, the waffle pattern comprises rows 1318a, 1318b, and 1318c of rectangles 1314. The rows 1318a-c of rectangles 1314 are defined by the thickness of the vertical and horizontal traces (e.g., connection lines 1312). In addition to the thickness of the vertical and horizontal traces, the position of the path which the vertical and horizontal traces follow also contributes to the defined rows and rectangles. In the embodiment of FIGS. 13A and 13B, the rows 1318a-c have the same dimensions and number of rectangles 1314. The rows 1318a-c can also be configured to have different numbers of rectangles 1314 within a given row 1318a-c to provide the desired read range properties.

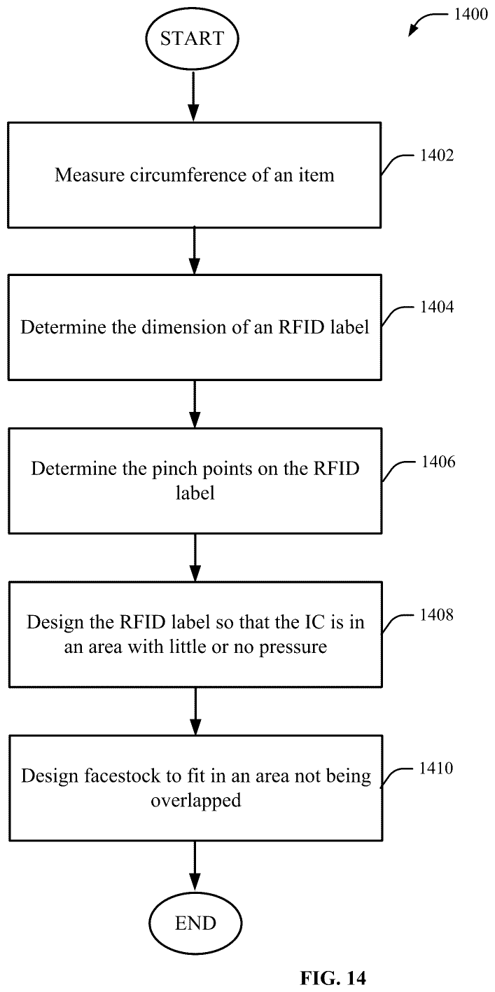

FIG. 14 illustrates a flow diagram in accordance with various disclosed aspects herein to illustrate the methods of creating an overlapped RFID label to provide extra protection to the IC while avoiding the pinch points of a label applicator. At step 1402, the method 1400 can comprise measuring the circumference of an item such as, but not limited to, a vial. At step 1404, the method 1400 can comprise determining the dimension of the RFID label such as the length of the RFID label so that either the leading edge or the rear edge of the RFID label overlap the other. At step 1406, the method 1400 can comprise determining the pinch points of the RFID label from a label applicator. At step 1408, the method 1400 can comprise designing the RFID label so that the IC is in an area with little or no pressure thereby avoiding the pinch points. At step 1410, the method 1400 can comprise designing the facestock to fit in an area not being overlapped by the RFID label when the RFID label is applied on the item.

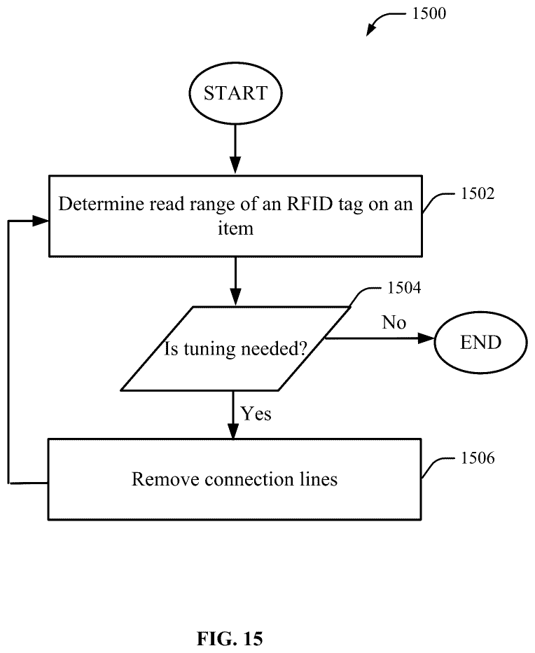

FIG. 15 illustrates a flow diagram in accordance with various disclosed aspects herein to illustrate the methods of tuning an RFID tag. At step 1502, the method 1500 can comprise determining the read range an RFID tag on an item. At step 1504, the method 1500 can comprise determining whether tuning is needed. If no, the read range of the RFID tag on the item is within a desired read range then tuning is not needed, and the tuning process is complete. If yes, the read range of the RFID tag on the item is not within a desired read range then tuning is needed, and the process can proceed to step 1506. At step 1506, the method can comprise removing connection lines on the antenna of a cross hatch or waffle pattern RFID tag. When removing the connection lines on the antenna of a cross hatch or waffle pattern RFID tag, one or more connection lines can be removed so the connection lines that remain can maintain the enclosed rectangle shapes.

After step 1506, the method can continue to step 1502 to determine the read range again of the RFID tag. The read range can be easily and quickly determined by using an RFID reader. The process can continue until it is determined that no tuning is needed.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components or methodologies described above may be combined or added together in any permutation. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An RFID inlay comprising:
a substrate defined by a first edge and a second edge opposing the first edge; and
an antenna disposed on the substrate, wherein the antenna includes a loop and a first antenna pattern extending from the loop, wherein the loop is disposed adjacent to the first edge, and wherein the first antenna pattern is disposed between the loop and the second edge and is asymmetrical relative to the loop.

2. The RFID inlay of claim 1, wherein the first antenna pattern is defined by a plurality of first connection lines and a plurality of second connections lines, wherein the plurality of second connection lines are perpendicular to the first connection lines, wherein the first connection lines and the second connection lines respectively define a plurality of rectangles.

3. The RFID inlay of claim 2, wherein the plurality of first connection lines and the plurality of second connection lines define a first row of rectangles.

4. The RFID inlay of claim 3, wherein the plurality of first connection lines and the plurality of second connection lines define a second row of rectangles, wherein a number of rectangles in the first row of rectangles is different than a number of rectangles in the second row of rectangles.

5. The RFID inlay of claim 4, wherein the first row of rectangles has a different length than the second row of rectangles.

6. The RFID inlay of claim 1, wherein the antenna includes a second antenna pattern extending from the loop and disposed between the first edge and the loop, wherein each of the first antenna pattern and the second antenna pattern is asymmetrical relative to the loop.

7. The RFID inlay of claim 1, wherein the first antenna pattern comprises an asymmetric dipole including a solid bar.

8. The RFID inlay of claim 1, wherein the first antenna pattern is defined by a plurality of first connection lines and a plurality of second connections lines, wherein the plurality of second connection lines are perpendicular to the first connection lines, wherein at least one of the plurality of first connection lines comprises a first thickness, and wherein at least one of the plurality of second connection lines comprises a second thickness, wherein the second thickness is different than the first thickness.

9. The RFID inlay of claim 1, wherein the inlay further comprises an integrated circuit connected to the loop, wherein the loop is configured to provide inductance for the integrated circuit.

10. The RFID inlay of claim 1, wherein the first antenna pattern comprises at least one meander line.

11. A label comprising:
an RFID inlay with a substrate including a first edge and a second edge spaced apart from the first edge, wherein the substrate includes an integrated circuit and an antenna thereon, and wherein the antenna includes a loop and an antenna pattern extending from the loop, wherein the antenna pattern is disposed on a side of the loop and asymmetrical relative thereto; and
a facestock disposed about the RFID inlay and in a stacked arrangement therewith, wherein the facestock comprises at least one of: an electronic product code, indicia, printed artwork, and information.

12. The label of claim 11, wherein the first edge is a leading edge, and the second edge is a rear edge, wherein the label is dimensioned such that the rear edge overlaps the leading edge to define an overlapped portion when the label is applied about a circumference of an item.

13. The label of claim 12, wherein the at least one of the electronic product code, indicia, printed artwork, and information is not disposed in the overlapped portion.

14. The label of claim 11, wherein the label further comprises a transparent film disposed about the facestock, wherein the film comprises polyethylene terephthalate.

15. The label of claim 11, wherein the antenna pattern is defined by a plurality of first connection lines and a plurality of second connections lines, wherein the plurality of second connection lines are perpendicular to the plurality of first connection lines, wherein the plurality of first connection lines and the plurality of second connection lines define a plurality of rectangles.

16. A method of preparing an RFID label comprising a printed facestock and a substrate with a leading edge and a rear edge, wherein the substrate includes an antenna thereon, said antenna including an antenna pattern, a loop, and an integrated circuit, wherein the integrated circuit is disposed adjacent a rear edge of the substrate, the method comprising:
measuring a circumference of an item to which the RFID label will be applied; and
determining a length between the leading edge and the rear edge based on the circumference to define an overlap portion such that the integrated circuit is disposed in the overlap portion and the printed facestock is not disposed in the overlap portion.

17. The method of claim 16, wherein the antenna pattern is defined by a plurality of connection lines disposed asymmetrically relative to the loop, wherein the method further comprises:
optimizing the read range, frequency response, or resonant frequency of the RFID label by altering at least one of the connection lines.

18. The method of claim 17, wherein the method further comprises:
determining dielectric properties of the object to which the label will be applied; and
optimizing the read range based on the dielectric properties of the object.

19. The method of claim 17, wherein the at least one of the connection lines is removed via a die cut during a label conversion process.

20. The method of claim 16, the method further comprising:
identifying a pinch point of the label based on a label applicator to be employed for applying the RFID label; and
adjusting a location of the integrated circuit based on the pinch point.
